(19) United States
(12) Patent Application Publication
(10) Pub. No.: US 2026/0326602 A1
(43) Pub. Date: Oct. 22, 2026

(54) ENERGY SHARING SYSTEM AND METHOD

(71) Applicants: Hyundai Motor Company, Seoul (KR); Kia Corporation, Seoul (KR)

(72) Inventors: Byunghong LEE, Hwaseong-SI (KR); Rira Kang, Hwaseong-Si (KR); Minjae Lee, Hwaseong-Si (KR); Yeonghee Lee, Hwaseong-Si (KR)

(73) Assignees: Hyundai Motor Company, Seoul (KR); Kia Corporation, Seoul (KR)

(21) Appl. No.: 19/327,524

(22) Filed: Sep. 12, 2025

(30) Foreign Application Priority Data
Apr. 22, 2025 (KR) 10-2025-0052288

(51) Int. Cl. B60L 53/62; B60L 53/51; B60L 53/53; B60L 53/57; B60L 53/66; B60L 53/67

(52) U.S. Cl. CPC B60L 53/62; B60L 53/51; B60L 53/53; B60L 53/57; B60L 53/66; B60L 53/67; B60L 2240/72

(57) ABSTRACT

An energy sharing system may include an energy production device producing and storing energy, an energy delivery device delivering the energy of the energy production device in response to an energy charging request from an electronic device, and a server configured to perform communication with the energy production device, the energy delivery device, and the electronic device. A method according to another exemplary embodiment of the present disclosure may include receiving an energy charging request from an electronic device, determining an energy production device, and transmitting a delivery request to an energy delivery device.

### CROSS-REFERENCE TO RELATED APPLICATION

This present application claims the benefit of priority to Korean Patent Application No. 10-2025-0052288, filed on Apr. 22, 2025, the entire contents of which is incorporated herein for all purposes by this reference.

### FIELD

The present disclosure relates to an energy sharing system and method.

### BACKGROUND

According to carbon neutrality policies, the automobile market is shifting from internal combustion engine-centered to electric vehicle-centered. However, driving range limitations of electric vehicles and lack of charging infrastructure are acting as purchase barriers for consumers.

Accordingly, if sufficient charging infrastructure for electric vehicles is established, the electric vehicle market may experience explosive growth.

The matters described in this Background section are only for enhancement of understanding of the general background of the present disclosure, and should not be taken as acknowledgement that they correspond to related art already known to those skilled in the art.

### BRIEF SUMMARY

The following summary presents a simplified summary of certain features. The summary is not an extensive overview and is not intended to identify key or critical elements.

In various aspects of the present disclosure, the present disclosure is directed to providing an energy sharing system and method for production, requesting, delivery, and supply of energy.

In various aspects of the present disclosure, the present disclosure is further directed to providing, in particular, an energy sharing system and method configured for optimizing electric vehicle charging and power trading.

In various aspects of the present disclosure, an energy sharing system may include an energy production device producing and storing energy, an energy delivery device delivering the energy of the energy production device in response to an energy charging request from an electronic device, and a server configured to perform communication with the energy production device, the energy delivery device, and the electronic device.

In various aspects of the present disclosure, the server may be configured to receive an energy charging request from the electronic device and to determine an energy production device and an energy delivery device based on at least one of location information of the electronic device, a requested charging amount of the electronic device, location information of the energy production device, location information of the energy delivery device, or an energy storage amount of the energy production device.

In various aspects of the present disclosure, the server may be configured to receive location information and a requested charging amount of the electronic device, determine an energy production device located at a closest distance from a location of the electronic device, and transmit an energy storage amount confirmation request to the determined energy production device.

In various aspects of the present disclosure, the server may be configured to receive location information and a requested charging amount of the electronic device, determine an energy delivery device located at a closest distance from a location of the electronic device, determine an energy production device located at a closest distance from the determined energy delivery device, and transmit an energy storage amount confirmation request to the determined energy production device.

In various aspects of the present disclosure, the server may be configured to determine whether the requested charging amount is less than or equal to an energy storage amount of the determined energy production device, and based on the requested charging amount being less than or equal to the energy storage amount of the determined energy production device, determine the energy production device as a final energy production device.

In various aspects of the present disclosure, the server may be configured to determine an energy delivery device located at a closest distance from the final energy production device.

In various aspects of the present disclosure, the server may be configured to transmit a delivery request to the determined energy delivery device.

In various aspects of the present disclosure, the server may be configured to transmit, to the determined energy delivery device, location information of the final energy production device and location information of the electronic device.

In various aspects of the present disclosure, the energy production device may include a photovoltaic power generation device.

In various aspects of the present disclosure, the energy production device may include at least one of a solar dome structure including a photovoltaic power generation device or a smart tree structure including a photovoltaic power generation device.

In various aspects of the present disclosure, the energy production device may include a first communication unit, an energy production unit including a photovoltaic power generation device, and a first energy storage unit configured to store energy produced from the energy production unit.

In various aspects of the present disclosure, the first energy storage unit may include an energy storage system ESS.

In various aspects of the present disclosure, the energy delivery device may include at least one of an unmanned energy transport vehicle or an unmanned energy transport robot.

In various aspects of the present disclosure, the energy delivery device may include a second communication unit, a second energy storage unit configured to store energy, and an energy providing unit configured to provide energy.

In various aspects of the present disclosure, a method may include receiving an energy charging request from an electronic device, determining an energy production device, and transmitting a delivery request to an energy delivery device.

In various aspects of the present disclosure, the method may further include, after the receiving of the energy charging request, determining a location of the electronic device, wherein the determining of the energy production device includes determining an energy production device located at a closest distance from the location of the electronic device.

In various aspects of the present disclosure, the method may further include, after the determining of the energy production device, receiving energy storage amount information from the energy production device, comparing an energy storage amount of the energy production device with a requested charging amount, and based on the requested charging amount being greater than or equal to the energy storage amount, determining the energy production device as a final energy production device.

In various aspects of the present disclosure, the method may further include determining an energy delivery device located at a closest distance from the final energy production device.

In various aspects of the present disclosure, the determining of the energy production device may include determining an energy delivery device located at a closest distance from a location of the electronic device, and determining an energy production device located at a closest distance from the determined energy delivery device.

In various aspects of the present disclosure, the transmitting a delivery request to an energy delivery device may include transmitting location information of a final energy production device and location information of the electronic device.

The energy sharing system and method of the present disclosure may enable real-time energy charging requests and reservations, and assign optimal energy production devices and energy delivery devices.

The energy sharing system and method of the present disclosure may efficiently establish a system for energy production, requesting, delivery, and supply. The energy sharing system and method of the present disclosure may optimize energy sharing, electric vehicle charging, and power trading. Accordingly, an energy sharing network may be established through the energy sharing system and method of the present disclosure.

The effects of the present disclosure are not limited to those mentioned above, and other effects not mentioned will be clearly understood by those skilled in the art from the following description.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a block diagram illustrating an energy sharing system according to various exemplary embodiments of the present disclosure.

FIG. 2A, FIG. 2B, FIG. 2C, FIG. 2D, and FIG. 2E are diagrams illustrating examples of an energy production device according to various exemplary embodiments of the present disclosure.

FIG. 3 is a schematic diagram illustrating an internal structure of an energy production device according to various exemplary embodiments of the present disclosure.

FIG. 4 is a diagram illustrating an example of an energy production device according to various exemplary embodiments of the present disclosure.

FIG. 5 is an operation flowchart illustrating a method according to various exemplary embodiments of the present disclosure.

FIG. 6 is a schematic diagram illustrating a method according to various exemplary embodiments of the present disclosure.

FIG. 7 is an operation flowchart illustrating a method according to another exemplary embodiment of the present disclosure.

### DETAILED DESCRIPTION

Embodiments described in the present specification may be modified into various other forms, and the technology according to exemplary embodiments of the present disclosure is not limited to the exemplary embodiments described below. The exemplary embodiments are provided to make the description of the present disclosure thorough and to fully convey the scope of the present disclosure to those skilled in the art.

Singular forms “a,” “an,” and “the” used in the specification and the appended claims are intended to include plural referents unless the context clearly dictates otherwise.

In addition, numerical ranges used in the present specification may include all values between the lower and upper limits, all values incrementally derived logically within shape and breadth of the defined ranges, all double-limited values, and all possible combinations of upper and lower limits of differently limited numerical ranges. Unless specifically defined in the present specification, values outside the defined numerical ranges that may occur due to experimental error or rounding off of values are also included within the defined numerical ranges.

Furthermore, reference throughout the specification to “including” or “comprising” a constituent element means that, unless specifically stated to the contrary, other constituent elements are not excluded and may be included.

Furthermore, terms including ordinals such as first, second, etc. may be used to describe various elements, but the elements are not limited by these terms. These terms are only used to distinguish one constituent element from another.

It will be understood that each block in the flowchart illustrations, as well as combinations of blocks, may be implemented by computer program instructions. These instructions may be loaded onto a processor of a general-purpose computer, special-purpose computer, or other programmable data processing device so that the instructions, when executed by the processor, cause the device to perform the functions specified in the flowchart block(s). The computer program instructions may also be stored in a computer-usable or computer-readable memory that can direct a computer or other programmable data processing device to function in a particular manner so that the instructions stored in the memory produce an article of manufacture that includes instruction means for implementing the functions specified in the flowchart block(s). The computer program instructions may also be loaded onto a computer or other programmable data processing device to cause a series of operational steps to be executed, implementing a computer-implemented process that is configured to perform the functions specified in the flowchart block(s).

Each block in the flowcharts may represent a module, segment, or portion of code including one or more executable instruction(s) for implementing the specified logical functions. In some implementations, the functions described in the blocks may be performed in a different order than presented. For example, two blocks shown in succession may be executed substantially concurrently, or in some cases, in reverse order, depending on the functionality involved.

As used herein, the term “unit” refers to a software or hardware component, such as a field programmable gate array (FPGA) or an application specific integrated circuit (ASIC), that is configured to perform a specific function. However, the term is not limited to software or hardware alone. A “unit” may be implemented in an addressable storage medium or may represent one or more processors. Accordingly, a “unit” may include components such as software modules, object-oriented software components, class components, task components, processes, functions, attributes, procedures, subroutines, segments of program code, drivers, firmware, microcode, circuits, data, databases, data structures, tables, arrays, or variables. The functions provided by the components and units may be combined into fewer components or units, or separated into additional components or units. Moreover, the components and units may be implemented using one or more central processing units CPUs in a device or a secure multimedia card. In various exemplary embodiments of the present disclosure, a unit may include one or more processors.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Furthermore, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

According to various exemplary embodiments of the present disclosure, an energy sharing system and method for energy production, requesting, delivery, and supply is provided. According to various exemplary embodiments of the present disclosure, an efficient energy sharing system and method combining IoT connectivity and an energy delivery system based on an eco-friendly power generation system is proposed. According to various exemplary embodiments of the present disclosure, particularly, an energy sharing system and method configured for optimizing electric vehicle charging and power trading is provided.

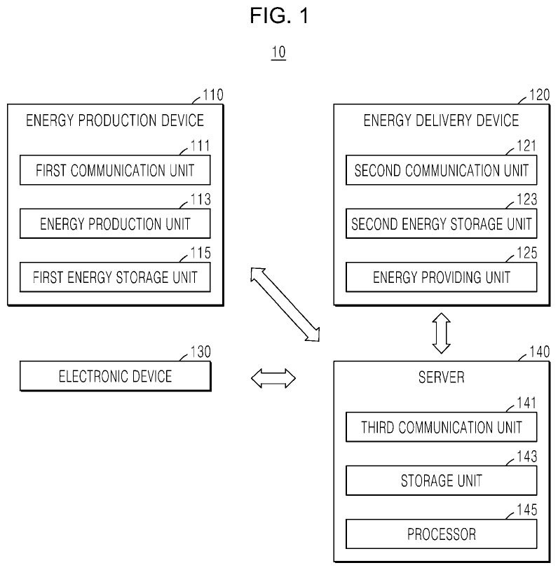

FIG. 1 is a block diagram illustrating an energy sharing system according to various exemplary embodiments of the present disclosure.

Referring to FIG. 1, the energy sharing system 10 may include an energy production device 110, an energy delivery device 120, an electronic device 130, and a server 140.

The energy production device 110 may produce and store energy. The energy production device 110 may include a first communication unit 111, an energy production unit 113, and a first energy storage unit 115.

While FIG. 1 shows the first communication unit 111, the energy production unit 113, and the first energy storage unit 115 as components of the energy production device 110, these represent only some components of the energy production device 110, and the energy production device 110 may include various other components.

The first communication unit 111 may perform communication with at least one of the energy delivery device 120, the electronic device 130, or the server 140 using various communication methods.

For example, the first communication unit 111 may perform communication with at least one of the energy delivery device 120, the electronic device 130, or the server 140 using a wired/wireless local area network (LAN), WAN, Ethernet, Bluetooth, Zigbee, Universal Serial Bus (USB), IEEE 1394, Wi-Fi, or the like.

The energy production unit 113 may include, for example, a photovoltaic power generation device. The energy production unit 113 may include at least one solar cell selected from the group consisting of dye-sensitized solar cells, crystalline silicon solar cells, amorphous silicon solar cells, organic solar cells OPV, quantum dot solar cells, perovskite-based solar cells, and compound solar cells such as CIGS and CdTe.

The first energy storage unit 115 may store energy produced from the energy production unit 113. The first energy storage unit 115 may include a battery that charges power produced from the energy production unit 113. The first energy storage unit 115 may include, for example, an energy storage system ESS.

The energy production device 110 may include a photovoltaic power generation device. The energy production device 110 may be at least one of a solar dome structure including a photovoltaic power generation device or a smart tree structure including a photovoltaic power generation device.

The energy production device 110 may be disposed in urban areas or on building rooftops. A cluster may be formed by installing a plurality of energy production devices 110 within a predetermined distance of one another. Energy sharing may be possible between energy production devices 110 within the same cluster.

The energy production device 110 may receive an energy storage amount confirmation request from the server 140. When the energy production device 110 receives an energy storage amount confirmation request from the server 140, the energy production device 110 may transmit energy storage amount information stored in the first energy storage unit 115 to the server 140.

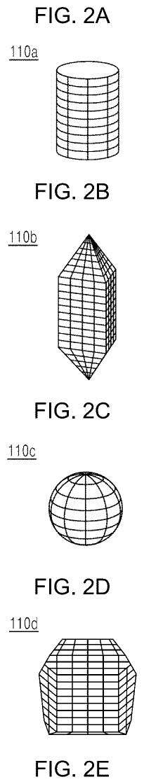

FIGS. 2A, 2B, 2C, 2D, and 2E are diagrams illustrating examples of an energy production device according to various exemplary embodiments of the present disclosure.

Referring to FIGS. 2A, 2B, 2C, 2D, and 2E, energy production devices 110a, 110b, 110c, 110d, 110e may include a solar dome structure to increase the duration of solar exposure. In configurations where the energy production devices 110a, 110b, 110c, 110d, 110e include a solar dome structure, the external surface may include at least one solar cell selected from the group consisting of silicon-based solar cells, compound semiconductor solar cells, perovskite solar cells, and hybrid solar cells.

The energy production devices 110a, 110b, 110c, 110d, 110e may be disposed in urban spaces and/or on building rooftops. The energy production devices 110a, 110b, 110c, 110d, 110e may have various designs considering aesthetics, such as cylindrical, polygonal, and dome shapes, as shown in FIGS. 2A, 2B, 2C, 2D, and 2E.

Although not shown in the drawings, the energy production devices 110a, 110b, 110c, 110d, 110e may include rotating panels to optimize solar exposure. For example, the rotating panels may be disposed to rotate the solar dome structure to increase solar exposure and/or the duration of exposure according to the angle of sunlight.

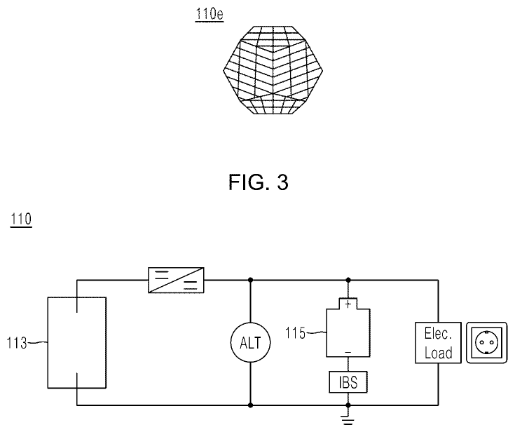

FIG. 3 is a schematic diagram illustrating an internal structure of an energy production device according to various exemplary embodiments of the present disclosure.

Referring to FIG. 3, the energy production device 110 may include the energy production unit 113 and the first energy storage unit 115, and the energy production unit 113 may be various types of solar cells as described above. Power generated from the energy production unit 113 may be stored in the first energy storage unit 115. The first energy storage unit 115 may be a battery or ESS system as described above. The power produced from the energy production unit 113 may be stably managed using an accelerated lifetime testing (ALT) device.

An intelligent battery sensor (IBS) functionally connected to the first energy storage unit 115 may monitor and manage the condition of the battery by measuring the battery's voltage, current, and temperature in real time.

Power stored in the first energy storage unit 115 may be used through an electrical load (Elec. Load) and a power outlet. Accordingly, the energy production device 110 may supply power to various electronic devices such as the energy delivery device 120 and electric vehicles.

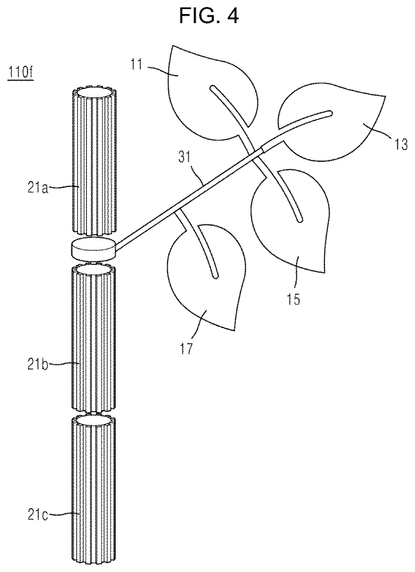

FIG. 4 is a diagram illustrating an example of an energy production device according to various exemplary embodiments of the present disclosure.

Referring to FIG. 4, an energy production device 110f may include a smart tree structure. The smart tree may be configured with a modular structure. The smart tree may be configured with a modular structure including components that perform various functions. The smart tree may include a multifunctional module disposed with photovoltaic power generation, radiative cooling, air purification, and CO₂ reduction functions. Each module may operate independently or be interconnected to support efficient energy production and environmental improvement.

The smart tree may include leaf-shaped modules with various functions. For example, the smart tree may include a solar cell leaf module 11, a radiative cooling leaf module 13, an air purification leaf module 15, and a carbon dioxide CO₂ purification leaf module 17.

The solar cell leaf module 11 may produce energy. The solar cell leaf module 11 may include a solar cell. The solar cell leaf module 11 may include at least one solar cell selected from the group consisting of dye-sensitized solar cells, crystalline silicon solar cells, amorphous silicon solar cells, organic solar cells OPV, quantum dot solar cells, perovskite-based solar cells, and compound solar cells such as CIGS and CdTe. The solar cell leaf module 11 may include a perovskite solar cell. Since perovskite solar cells have high conversion efficiency and may be manufactured to be flexible, they may be easier to apply to curved structures or non-uniform designs than silicon solar cells.

The solar cell leaf module 11 may include, in order, a transparent substrate layer, a first transparent electrode layer, a charge transport layer, a perovskite absorption layer, a hole transport layer, and a second transparent electrode layer.

The transparent substrate layer may be a flexible substrate in the shape of a leaf. For example, the transparent substrate layer may include at least one of a polymer, glass, or a flexible metal substrate. The polymer may include at least one selected from the group consisting of polyethylene terephthalate (PET), polyethylene naphthalate (PEN), and polyimide (PI).

The first transparent electrode layer and the second transparent electrode layer may collect current. The first transparent electrode layer and the second transparent electrode layer may include at least one selected from the group consisting of indium tin oxide (ITO), fluorine-doped tin oxide (FTO), and poly(3,4-ethylenedioxythiophene): polystyrene sulfonate (PEDOT: PSS).

The electron transport layer may collect electrons generated in the perovskite absorption layer. The electron transport layer may include organic-inorganic semiconductors for transporting electrons. For example, the electron transport layer may include at least one selected from the group consisting of TiO₂, SnO₂, ZnO, [6,6]-phenyl-C61-butyric acid methyl ester (PCBM), and a fullerene.

The perovskite absorption layer generates power by absorbing sunlight, and may include various perovskite materials. For example, the perovskite absorption layer may include organic-inorganic hybrid perovskite and/or mixed halide perovskite. For example, the perovskite absorption layer may include at least one selected from the group consisting of methylammonium lead iodide (MAPbI₃), formamidinium lead iodide (FAPbI₃), cesium lead iodide (CsPbI₃), MAPb(I₁₋ₓBrₓ)₃, and FA_{0.95}Cs_{0.05}Pb(I₁₋ₓBrₓ)₃.

The hole transport layer may collect holes generated in the perovskite absorption layer. The hole transport layer may include organic-inorganic semiconductors configured to transport holes. For example, the hole transport layer may be at least one selected from the group consisting of 2,2′,7,7′-tetrakis(N, N-di-p-methoxyphenylamine)-9,9′-spirobifluorene (spiro-OMeTAD), poly(triarylamine) PTAA), NiOₓ, CuSCN, and CuI.

When the energy production function of the energy production device 110f needs to be enhanced, more solar cell leaf modules 11 may be added to the smart tree. That is, the solar cell leaf modules 11 may be disposed in various numbers within the smart tree according to the required energy production amount.

The radiative cooling leaf module 13 may lower the surrounding temperature by reflecting sunlight and emitting infrared radiation through the principle of radiative cooling. The radiative cooling leaf module 13 may include a surface radiation layer, a radiative cooling layer, and a substrate layer.

The surface radiation layer may be a layer that reduces heat absorption by optimizing sunlight reflection. The surface radiation layer may include, for example, at least one selected from the group consisting of porous silica, alumina (Al₂O₃)-based thin films, and polymer nanocomposites.

The radiative cooling layer may be a layer that emits heat while reflecting specific wavelengths of sunlight. The radiative cooling layer may reduce the surrounding temperature by efficiently emitting infrared radiation.

The substrate layer may physically support the above-described components and may include a leaf shape. The substrate layer may include at least one selected from the group consisting of various polymers, glass fiber reinforced plastic, and carbon fiber.

When the cooling function of the energy production device 110f needs to be enhanced, more radiative cooling leaf modules 13 may be placed within the smart tree. That is, the radiative cooling leaf modules 13 may be provided in various numbers within the smart tree according to the season and temperature of the installation location.

The air purification leaf module 15 may perform an air purification function. The air purification leaf module 15 may perform its air purification function by decomposing or adsorbing air pollutants (fine dust, NOx, SOx, VOCs, and the like) in the air. The air purification leaf module 15 may include a protection layer, a photocatalyst layer, a filter layer, and a substrate layer.

The protection layer may protect the photocatalyst layer and enhance the durability of the air purification leaf module 15. The protection layer may include one selected from the group consisting of a fluorine coating layer, a silica coating layer, and an organic coating layer.

The photocatalyst layer may decompose harmful substances in the air using sunlight. The photocatalyst layer may include, for example, at least one selected from the group consisting of TiO₂, Cu₂O , ZnO, and WO₂.

The filter layer may be a layer that physically adsorbs fine dust, VOCs, and the like in the air. The filter layer may include, for example, one selected from the group consisting of activated carbon, graphene-based filter, and zeolite.

The substrate layer may physically support the above-described components and may include a leaf shape. The substrate layer may include at least one selected from the group consisting of porous silica, nanofibers, and porous aluminum oxide. by including a porous shape, the substrate layer may smoothly guide air flow and improve the purification effect.

When the air purification function of the energy production device 110f needs to be enhanced, more air purification leaf modules 15 may be placed within the smart tree. That is, the air purification leaf modules 15 may be disposed in various numbers within the smart tree according to the pollution concentration in the air.

The CO₂ purification leaf module 17 may enhance the carbon reduction effect by capturing, converting, and storing CO₂ from the air. The CO₂ purification leaf module 17 may include a protection layer, a CO₂ capture layer, a catalytic conversion layer, and a porous substrate layer.

The protection layer may protect the internal components from the external environment. The protection layer may protect the CO₂ capture layer and catalytic conversion layer, and guide air to diffuse into the CO₂ capture layer and catalytic conversion layer. The protection layer may include one selected from the group consisting of a water-resistant coating layer and a porous silica protection layer.

The CO₂ capture layer may be a layer that selectively adsorbs CO₂ from the air and may include a porous structure. By including a porous structure, the CO₂ capture layer may increase the contact area with air. The CO₂ capture layer may include one selected from the group consisting of metal-organic frameworks (MOF), zeolite, amine-functionalized silica, and carbon nanotube (CNT)-based adsorbents.

The catalytic conversion layer may convert captured CO₂ into useful materials through electrochemical reaction or photocatalytic reaction. For example, the catalytic conversion layer may convert CO₂ into CO, methanol, or hydrocarbons. The CO, methanol, or hydrocarbons that have been converted by the catalytic conversion layer may also be used as fuel.

The porous substrate layer may physically support the above-described components and may include a leaf shape. The porous substrate layer may optimize air flow to increase CO₂ capture efficiency. The porous substrate layer may include porous silica nanofibers, mesoporous carbon, and/or anodized aluminum oxide (AAO).

When the CO₂ reduction function of the energy production device 110f needs to be enhanced, more CO₂ purification leaf modules 17 may be placed within the smart tree. That is, the CO₂ purification leaf modules 17 may be disposed in various numbers within the smart tree according to the CO₂ concentration in the air.

While it has been described that the solar cell leaf module 11, radiative cooling leaf module 13, air purification leaf module 15, and CO₂ purification leaf module 17 each form a single leaf module, this is not limiting, and a single leaf module may perform two or more functions. For example, a single leaf module may perform at least two or more functions among photovoltaic power generation, radiative cooling, air purification, and CO₂ purification. In the instant case, a single leaf module may include a layer configuration enabling performance of at least two of the above functions among photovoltaic power generation, radiative cooling, air purification, and CO₂ purification. For example, when a single leaf module performs both photovoltaic power generation and radiative cooling functions, the single leaf module may include layers for performing both solar cell and radiative cooling functions.

The energy production device 110f including a smart tree structure may include branch-shaped modules 31 that perform various functions. The branch-shaped modules 31 may allow the above-described leaf modules to be stably fixed. The branch-shaped modules 31 may include a structure that allows leaf modules to be detachably attached. Therefore, various leaf modules may be attached according to required functions, and leaf modules requiring maintenance may easily be replaced.

For example, the branch-shaped modules 31 may be combined with the above-described solar cell leaf module 11, radiative cooling leaf module 13, air purification leaf module 15, and CO₂ purification leaf module 17 through magnetic coupling, clip-type fixing, screw coupling, or similar methods. Additionally, power and data may be connected to each leaf module wirelessly or through wired methods.

The branch-shaped modules 31 may also include solar-powered LEDs. Therefore, the branch-shaped modules 31 may provide light to the area where the smart tree is disposed.

The energy production device 110f including a smart tree structure may include tree trunk-shaped modules 21a, 21b, 21c that perform various functions. The tree trunk-shaped modules 21a, 21b, 21c may include a battery that stores power produced by the solar cell leaf module 11. For example, the tree trunk-shaped modules 21a, 21b, 21c may include an energy storage system (ESS).

The tree trunk-shaped modules 21a, 21b, 21c may include fine dust measurement sensors and/or air quality measurement sensors. Therefore, the tree trunk-shaped modules 21a, 21b, 21c may detect changes in pollutants in the area where the smart tree is disposed.

The tree trunk-shaped modules 21a, 21b, 21c may include a communication module. The tree trunk-shaped modules 21a, 21b, 21c may perform communication with the energy delivery device 120, the electronic device 130, and the server 140. The tree trunk-shaped modules 21a, 21b, 21c may transmit and receive data with the energy delivery device 120, the electronic device 130, and the server 140, and monitor the environment of the area where the smart tree is disposed.

The tree trunk-shaped modules 21a, 21b, 21c may include a power outlet. Therefore, the energy production device 110f may supply power to various electronic devices including the energy delivery device 120 and electric vehicles.

The tree trunk-shaped modules 21a, 21b, 21c may include a display. The tree trunk-shaped modules 21a, 21b, 21c may display detected data or received data through the display.

The tree trunk-shaped modules 21a, 21b, 21c may include closed-circuit television (CCTV). That is, the tree trunk-shaped modules 21a, 21b, 21c may include surveillance cameras for urban security, traffic monitoring, disaster detection, and the like.

Referring back to FIG. 1, the energy delivery device 120 may include a second communication unit 121, a second energy storage unit 123, and an energy providing unit 124. The energy delivery device 120 may deliver energy from the energy production device 110 in response to an energy charging request from the electronic device 130.

While FIG. 1 shows the second communication unit 121, the second energy storage unit 123, and the energy providing unit 124 as components of the energy delivery device 120, these represent only some components, and the energy delivery device 120 may include various other components.

The second communication unit 121 may perform communication with at least one of the energy production device 110, the electronic device 130, or the server 140 using various communication methods.

For example, the second communication unit 121 may perform communication with at least one of the energy production device 110, the electronic device 130, or the server 140 using a wired/wireless local area network (LAN), WAN, Ethernet, Bluetooth, Zigbee, Universal Serial Bus (USB), IEEE 1394, Wi-Fi, and the like.

The second energy storage unit 123 may receive and store energy produced by the energy production unit 113. The second energy storage unit 123 may include a battery that stores power transferred from the energy production unit 113. The second energy storage unit 123 may include, for example, an energy storage system (ESS).

The energy providing unit 124 may provide energy to various devices requiring energy charging. For example, the energy providing unit 124 may provide power to various devices for electrical charging. The energy providing unit 124 may provide energy through wired charging or wireless charging methods. When the energy providing unit 124 operates in a wired charging mode, the energy providing unit 124 may provide energy using charging plugs or charging cables. Therefore, the energy providing unit 124 may include charging plugs, charging cables, power converters, and the like.

When the energy providing unit 124 operates in a wireless charging mode, the energy providing unit 124 may transfer power through magnetic induction or magnetic resonance methods. Therefore, the energy providing unit 124 may include wireless charging pads, receiving coils, power converters, and the like.

The energy delivery device 120 may be at least one of an unmanned energy transport vehicle or an unmanned energy transport robot. The energy delivery device 120 may operate using autonomous driving-based route optimization technology.

The energy delivery device 120 may include vehicle integrated photovoltaic VIPV solar cells on the vehicle's roof or external panels. Therefore, power may be continuously produced even during operation of the energy delivery device 120.

The energy delivery device 120 may receive an energy delivery request from the server 140. The energy delivery device 120 may receive a delivery request including location information of a final energy production device 110 and location information of an electronic device 130 from the server 140. The energy delivery device 120 may move to the final energy production device 110 based on the received location information. The energy delivery device 120 may charge energy from the final energy production device 110. The energy delivery device 120 may move based on the location information of the electronic device 130. The energy delivery device 120 may deliver and provide energy to devices requiring energy charging.

Referring to FIG. 1, the server 140 may include a third communication unit 141, a storage unit 143, and a processor 145.

The third communication unit 141 may perform communication with at least one of the energy production device 110, the energy delivery device 120, or the electronic device 130 using various communication methods.

For example, the third communication unit 141 may perform communication with at least one of the energy production device 110, the energy delivery device 120, or the electronic device 130 using a wired/wireless local area network (LAN), WAN, Ethernet, Bluetooth, Zigbee, Universal Serial Bus (USB, IEEE 1394, Wi-Fi, and the like.

The storage unit 143 may store instructions which may be executed by the processor 145 of the server 140. The storage unit 143 may store instructions for energy production, delivery, and charging. The storage unit 143 may store instructions for determining assigning the energy production device 110 and/or energy delivery device 120 in response to a charging request from the electronic device 130.

The storage unit 143 may store data for energy production, delivery, and charging. The storage unit 143 may store, for example, location information data of the energy production device 110 and energy delivery device 120, energy storage amount data of the energy production device 110, and the like.

The storage unit 143 may include flash memory, hard disk drives, micro-type multimedia cards, card-type memory (for example, secure digital (SD) memory or extended digital (XD) memory), random access memory (RAM), static random access memory (SRAM), read-only memory (ROM), electrically erasable programmable read-only memory (EEPROM), programmable read-only memory (PROM), magnetic memory, magnetic disks, optical disks, and the like.

The storage unit 143 may be implemented as internal memory included in the processor 145 or may be implemented as memory separate from the processor 145.

The processor 145 may perform overall control operations of the server 140. The processor 145 may include at least one processor 145. For example, the processor 145 may include one or more of a central processing unit (CPU), an application processor (AP), or a communication processor (CP).

The server 140 may receive an energy charging request from the electronic device 130. The server 140 may receive an energy charging request including location information of the electronic device 130 and/or a requested charging amount of the electronic device 130 from the electronic device 130. The server 140 may obtain the location information of the electronic device 130 and/or the requested charging amount of the electronic device 130.

The server 140 may be configured to determine (assign) the energy production device 110 and energy delivery device 120 based on at least one of the location information of the electronic device 130, the requested charging amount of the electronic device 130, location information of the energy production device 110, location information of the energy delivery device 120, or energy storage amount of the energy production device 110.

The server 140 may receive an energy charging request from the electronic device 130 and determine the energy production device 110 located at the closest distance from the location of the electronic device 130. The server 140 may transmit an energy storage amount confirmation request to the determined energy production device 110.

The server 140 may receive energy storage amount information from the determined energy production device 110.

The server 140 may compare the requested charging amount of the electronic device 130 and the energy storage amount of the determined energy production device 110. The server 140 may be configured to determine whether the requested charging amount of the electronic device 130 is less than or equal to the energy storage amount of the determined energy production device 110.

Based on the server 140 determining that the requested charging amount of the electronic device 130 is less than or equal to the energy storage amount of the determined energy production device 110, the server 140 may be configured to determine the determined energy production device 110 as the final energy production device.

Based on the server 140 determining that the requested charging amount of the electronic device 130 is greater than the energy storage amount of the determined energy production device 110, the server 140 may be configured to determine the energy production device located at the next closest distance to the electronic device 130 after the determined energy production device 110. Subsequently, the server 140 may be configured to determine the final energy production device by repeating the process of transmitting an energy storage amount confirmation request to the determined energy production device, receiving energy storage amount information, and comparing with the requested charging amount.

The server 140 may be configured to determine the energy delivery device 120 closest to the determined final energy production device 110. The server 140 may transmit a delivery request to the determined energy delivery device 120. The server 140 may transmit a delivery request including location information of the final energy production device 110 and location information of the electronic device 130 to the determined energy delivery device 120.

Meanwhile, the exemplary embodiments are not limited to the above, and the server 140 may also operate as follows.

The server 140 may receive an energy charging request from the electronic device 130 and determine the energy delivery device 120 located at the closest distance from the location of the electronic device 130.

The server 140 may be configured to determine the energy production device 110 located at the closest distance to the determined energy delivery device 120.

The server 140 may transmit an energy storage amount confirmation request to the determined energy production device 110.

The server 140 may receive energy storage amount information from the determined energy production device 110.

The server 140 may compare the requested charging amount of the electronic device 130 and the energy storage amount of the determined energy production device 110. The server 140 may be configured to determine whether the requested charging amount of the electronic device 130 is less than or equal to the energy storage amount of the determined energy production device 110.

Based on the server 140 determining that the requested charging amount of the electronic device 130 is less than or equal to the energy storage amount of the determined energy production device 110, the server 140 may be configured to determine the determined energy production device 110 as the final energy production device.

Based on the server 140 determining that the requested charging amount of the electronic device 130 is greater than the energy storage amount of the determined energy production device 110, the server 140 may be configured to determine the energy production device located at the next closest distance to the electronic device 130 after the determined energy production device 110. Subsequently, the server 140 may be configured to determine the final energy production device by repeating the process of transmitting an energy storage amount confirmation request to the determined energy production device, receiving energy storage amount information, and comparing with the requested charging amount.

The server 140 may transmit a delivery request to the determined energy delivery device 120. The server 140 may transmit a delivery request including location information of the final energy production device 110 and location information of the electronic device 130 to the determined energy delivery device 120.

The above-described operations may be executed or performed by the processor 145 of the server 140.

Referring again to FIG. 1, the electronic device 130 may be a smartphone, tablet PC, laptop, electric vehicle, server, or the like. Meanwhile, the above examples are merely illustrative for explaining the electronic device 130, and the electronic device 130 is not necessarily limited to the above-described devices.

The electronic device 130 may transmit an energy charging request to the server 140. For example, the electronic device 130 may transmit an energy charging request to the server 140 through an application. The electronic device 130 may transmit requested charging amount and location information, or the like to the server 140. The electronic device 130 may also transmit a desired charging time to the server 140. Here, the location information may be location information of the electronic device 130 or location information input by a user.

After transmitting an energy charging request to the server 140, the electronic device 130 may receive information related to the energy delivery device 120 determined through the server 140.

The energy sharing system of the present disclosure may enable real-time energy charging requests and reservations, and may assign optimal energy production devices 110 and energy delivery devices 120.

The energy sharing system of the present disclosure may efficiently establish a system for energy production, requesting, delivery and supply. The energy sharing system of the present disclosure may optimize energy sharing, electric vehicle charging, and power trading. Accordingly, an energy sharing network may be established through the energy sharing system of the present disclosure.

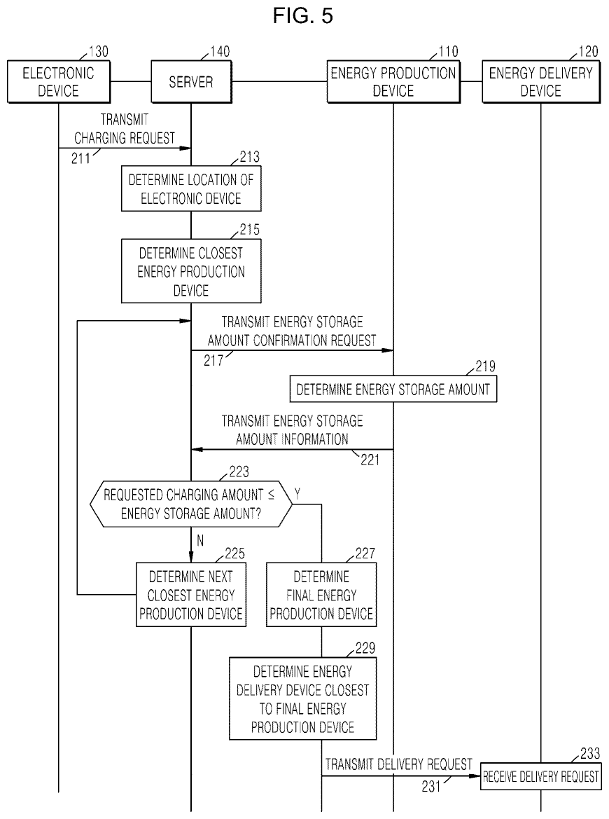

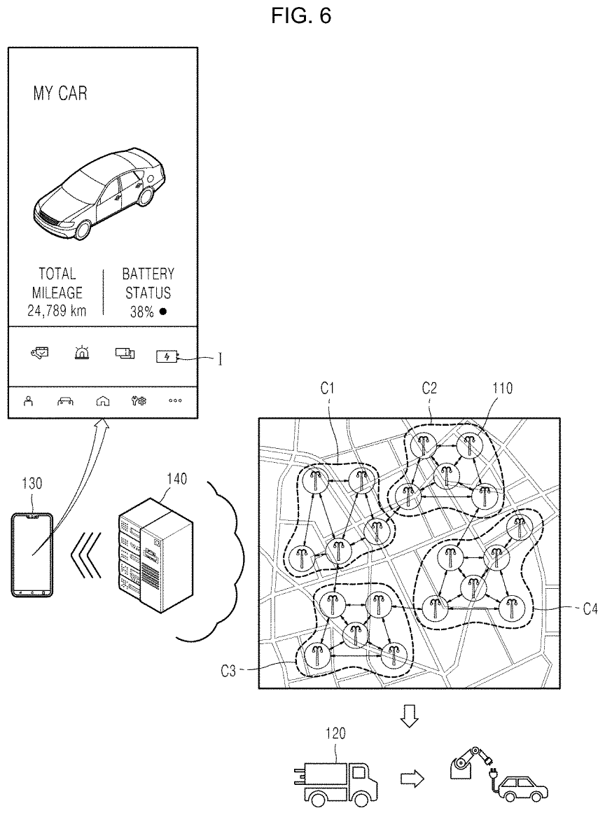

Hereinafter, a method according to various embodiments of the present disclosure will be described with reference to FIG. 5. FIG. 5 is an operation flowchart illustrating a method according to various exemplary embodiments of the present disclosure. FIG. 6 is a schematic diagram illustrating a method according to various exemplary embodiments of the present disclosure.

The method according to various embodiments of the present disclosure may include a method for operating an energy sharing system. The method according to various embodiments of the present disclosure may include an energy sharing method.

Referring to FIG. 5, the method according to an exemplary embodiment of the present disclosure may include receiving an energy charging request from an electronic device 130, determining an energy production device 110, and transmitting a delivery request to an energy delivery device 120.

The method according to an exemplary embodiment of the present disclosure may include transmitting, by the electronic device 130, an energy charging request to the server 140 in operation 211.

Referring to FIG. 6, the electronic device 130 may transmit an energy charging request to the server 140 through an application. For example, the application may be an application for controlling a vehicle. The application may provide information such as a total mileage of the vehicle, battery status, drivable distance, and the like. The application may display a charging request icon I. The electronic device 130 may transmit an energy charging request including location information and/or a requested charging amount of the electronic device 130 to the server 140 through the charging request icon I.

The server 140 may receive an energy charging request from the electronic device 130.

The method may include obtaining, by the server 140, location information of the electronic device 130 and determining a location of the electronic device 130 in operation 213. The method may include determining, by the server 140, an energy production device 110 located at the closest distance to the location of the electronic device 130 in operation 215. A plurality of energy production devices 110 may be disposed within a predetermined distance of one another to form clusters C1, C2, C3, C4, and the server 140 may also determine a cluster located at the closest distance to the location of the electronic device 130. The server 140 may also determine an energy production device 110 located at the closest distance to the location of the electronic device 130 within the determined cluster.

The method may include transmitting an energy storage amount confirmation request to the energy production device 110 determined in operation 215 in operation 217. The method may include determining, by the determined energy production device 110, an energy storage amount in operation 219. The method may include transmitting, by the determined energy production device 110, energy storage amount information to the server 140 in operation 221. That is, the method may include the server 140 receiving the energy storage amount information.

The method may include comparing the energy storage amount of the determined energy production device 110 with the requested charging amount of the electronic device 130 in operation 223. The method may include determining the energy production device 110 as a final energy production device based on determining that the requested charging amount is less than or equal to the energy storage amount in operation 227.

Meanwhile, the method may include, based on determining that the requested charging amount of the electronic device 130 is greater than the energy storage amount of the determined energy production device 110, determining an energy production device located at the next closest distance to the electronic device 130 in operation 225. Subsequently, the method may repeatedly perform the previously described operations of transmitting an energy storage amount confirmation request 217, determining the energy storage amount 219, transmitting energy storage amount information 221, and comparing 223.

The method may further include determining an energy delivery device located at the closest distance to the final energy production device in operation 229. The method may include transmitting, by the server 140, a delivery request to the determined energy delivery device 120 in operation 231. The server 140 may transmit a delivery request including location information of the final energy production device 110 and location information of the electronic device 130 to the determined energy delivery device 120.

The method may include receiving, by the energy delivery device 120, the delivery request in operation 233. In in operation 233, the energy delivery device 120 may receive, from the server 140, a delivery request including location information of the final energy production device 110 and location information of the electronic device 130. The energy delivery device 120 may move to the final energy production device 110 based on the received location information. The energy delivery device 120 may charge energy from the final energy production device 110. The energy delivery device 120 may move based on the location information of the electronic device 130. The energy delivery device 120 may deliver and provide energy to devices requiring energy charging.

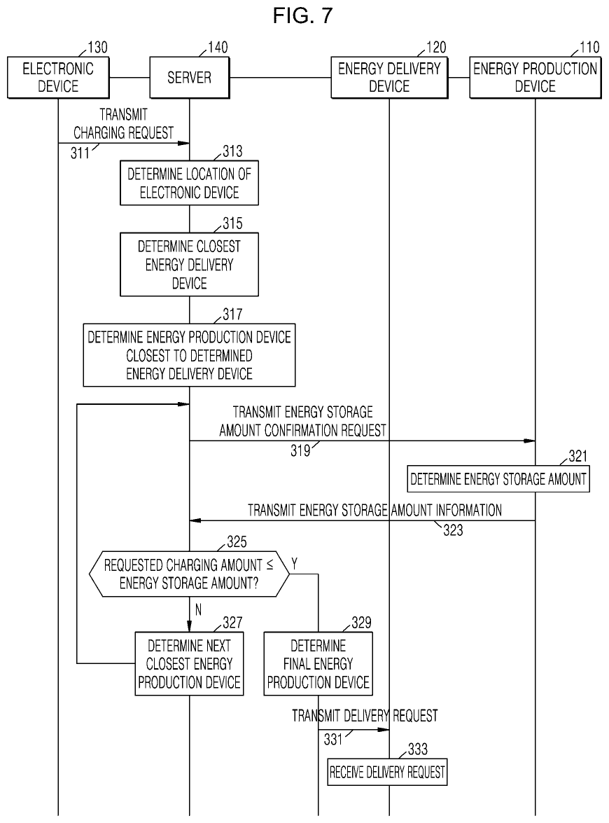

Hereinafter, a method according to various embodiments of the present disclosure will be described with reference to FIG. 7. FIG. 7 is an in operation flowchart illustrating a method according to another exemplary embodiment of the present disclosure. Descriptions may be omitted for configurations that overlap with the previously described content.

Referring to FIG. 7, the method according to another exemplary embodiment of the present disclosure may include transmitting, by the electronic device 130, an energy charging request to the server 140 in operation 311. The method may include obtaining, by the server 140, location information of the electronic device 130 and determining the location of the electronic device 130 in operation 313. The method may include determining, by the server 140, an energy delivery device 120 located at a closest distance from the location of the electronic device 130 in operation 315.

The method may include determining an energy production device 110 located at a closest distance from the energy delivery device 120 determined in in operation 315 in operation 317. The method may include transmitting an energy storage amount confirmation request to the energy production device 110 determined in in operation 317 in operation 319. The method may include determining, by the determined energy production device 110, an energy storage amount in operation 321. The method may include transmitting, by the determined energy production device 110, energy storage amount information to the server 140 in operation 323.

The method may include comparing the energy storage amount of the determined energy production device 110 with a requested charging amount of the electronic device 130 in operation 325. The method may include determining, by the server 140, the energy production device 110 as a final energy production device based on determining that the requested charging amount is less than or equal to the energy storage amount in operation 329.

The method may include transmitting, by the server 140, a delivery request to the determined energy delivery device 120 in operation 331. The method may include receiving, by the energy delivery device 120, the delivery request in operation 333.

The method of the present disclosure may enable real-time energy charging requests and reservations, and may assign optimal energy production devices 110 and energy delivery devices 120.

The method of the present disclosure may efficiently establish a system for energy production, requesting, delivery and supply. The method of the present disclosure may optimize energy sharing, electric vehicle charging, and power trading. Accordingly, an energy sharing network may be established through the method of the present disclosure.

Embodiments of the present disclosure have been described above with reference to the drawings. These are exemplary in nature, and the present disclosure is not limited to the exemplary embodiments and the content of the drawings described above.

It will be apparent to those skilled in the art that modifications may be made to the present disclosure within the scope of the included technical idea. The described embodiments should be considered as portion of the present disclosure, but the scope of the present disclosure should not be defined solely by the described embodiments.

The scope of the present disclosure should be determined by the technical idea set forth in the claims. Furthermore, in the description of the exemplary embodiments of the present disclosure, even if actions or effects according to the configuration are not explicitly described, actions or effects which may be predicted from the described configurations should also naturally be recognized as included in an exemplary embodiment of the present disclosure.

What is claimed is:

1. An energy sharing system comprising:
an energy production device producing and storing energy;
an energy delivery device delivering the energy of the energy production device based on an energy charging request received from an electronic device; and
a server configured to perform communication with the energy production device, the energy delivery device, and the electronic device.

2. The energy sharing system of claim 1, wherein the server receives an energy charging request from the electronic device, and determines an energy production device and an energy delivery device based on at least one of location information of the electronic device, a requested charging amount of the electronic device, location information of the energy production device, location information of the energy delivery device, or an energy storage amount of the energy production device.

3. The energy sharing system of claim 1, wherein the server
receives location information and a requested charging amount of the electronic device;
determines an energy production device located at a closest distance from a location of the electronic device; and
transmits an energy storage amount confirmation request to the determined energy production device.

4. The energy sharing system of claim 1, wherein the server
receives location information and a requested charging amount of the electronic device;
determines an energy delivery device located at a closest distance from a location of the electronic device;
determines an energy production device located at a closest distance from the determined energy delivery device; and
transmits an energy storage amount confirmation request to the determined energy production device.

5. The energy sharing system of claim 3, wherein the server
determines whether the requested charging amount of the electronic device is less than or equal to an energy storage amount of the determined energy production device; and
based on determining that the requested charging amount is less than or equal to the energy storage amount of the determined energy production device, determines the energy production device as a final energy production device.

6. The energy sharing system of claim 5, wherein the server determines an energy delivery device located at a closest distance from the final energy production device.

7. The energy sharing system of claim 6, wherein the server transmits a delivery request to the determined energy delivery device.

8. The energy sharing system of claim 6, wherein the server transmits, to the determined energy delivery device, location information of the final energy production device and location information of the electronic device.

9. The energy sharing system of claim 1, wherein the energy production device includes a photovoltaic power generation device.

10. The energy sharing system of claim 1, wherein the energy production device comprises at least one of a solar dome structure including a photovoltaic power generation device or a smart tree structure comprising a photovoltaic power generation device.

11. The energy sharing system of claim 1, wherein the energy production device comprises:
a first communication unit;
an energy production unit comprising a photovoltaic power generation device; and
a first energy storage unit storing energy produced from the energy production unit.

12. The energy sharing system of claim 11, wherein the first energy storage unit comprises an energy storage system (ESS).

13. The energy sharing system of claim 1, wherein the energy delivery device comprises at least one of an unmanned energy transport vehicle or an unmanned energy transport robot.

14. The energy sharing system of claim 1, wherein the energy delivery device comprises:
a second communication unit;
a second energy storage unit storing the energy; and
an energy providing unit providing the energy.

15. A method comprising:
receiving an energy charging request from an electronic device;
determining an energy production device; and
transmitting a delivery request to an energy delivery device.

16. The method of claim 15, further comprising:
after the receiving of the energy charging request, determining a location of the electronic device,
wherein the determining of the energy production device comprises determining an energy production device located at a closest distance from the location of the electronic device.

17. The method of claim 15, further comprising:
after the determining of the energy production device, receiving energy storage amount information from the energy production device;
comparing an energy storage amount of the energy production device with a requested charging amount; and
based on determining that the requested charging amount is less than or equal to the energy storage amount according to a result of the comparing, determining the energy production device as a final energy production device.

18. The method of claim 17, further comprising determining an energy delivery device located at a closest distance from the final energy production device.

19. The method of claim 15, wherein the determining of the energy production device comprises:
determining an energy delivery device located at a closest distance from a location of the electronic device; and
determining an energy production device located at a closest distance from the determined energy delivery device.

20. The method of claim 15, wherein the transmitting of the delivery request to the energy delivery device comprises transmitting location information of a final energy production device and location information of the electronic device to the energy delivery device.
